(19) United States
(12) Patent Application Publication
(10) Pub. No.: US 2022/0063798 A1
(43) Pub. Date: Mar. 3, 2022

(54) EXTENDABLE BLADE FOR DRONE SYSTEMS

(71) Applicant: Tyler Edward Johnson, Poway, CA (US)

(72) Inventor: Tyler Edward Johnson, Poway, CA (US)

(73) Assignee: Tyler Johnnson, Poway, CA (US)

(21) Appl. No.: 17/007,297

(22) Filed: Aug. 31, 2020

(51) Int. Cl. B64C 27/473; B64C 39/02; B64D 27/24; B64C 13/24; B64C 13/16

(52) U.S. Cl. CPC B64C 27/473; B64C 39/024; B64D 27/24; B64C 13/24; B64C 2201/201; B64C 2201/027; B64C 2201/042; B64C 2201/108; B64C 13/16

(57) ABSTRACT

The subject matter described herein provides for adaptive drone configurations that provide longitudinally extendable/retractable blade designs to enable dynamically adjustable drone configurations based on an application, condition, and/or requirement allowing for parameters such as such as battery life, flight time, flight distance, acceleration, and storage size to be optimized in real-time.

### FIELD OF THE INVENTION

This invention relates to longitudinally retractable/expandable propeller blades for use on unmanned aerial vehicle applications, such as drones.

### BACKGROUND OF THE INVENTION

Often drones are optimized for a particular application or use, but not easily adapted for a variety of different applications, conditions, or requirements, thereby requiring the designing, building, and/or purchasing of different drones for different applications.

### SUMMARY OF THE INVENTION

Unmanned Aerial Vehicles (UAVs), or drones, of the present invention have blades that are designed to adapt to different applications, conditions, and/or requirements by providing longitudinal extension of the blades to increase/decrease propeller wingspan. Longitudinal extension allows for larger lift area while minimizing increased power draw, thereby enabling optimized battery usage and flight time of the drone based on the application, condition, or requirement. Drone configurations described herein are dynamically adaptable for adjustment of power, lift, battery life and storage. Accordingly, a single drone may be useful for a variety of different applications such as delivery of different package sizes, environmental needs, and short- or long-range recreational usage. Furthermore, the drones described herein may be more readily adaptable to a variety of flying conditions, such as in urban areas, rural areas, and through varying weather conditions including high, low, and/or changing wind direction, speed and patterns. The adaptive use of the drones for a variety of different applications, conditions, or requirements may impact parameters such as such as battery life, flight time, flight distance, acceleration, and storage size. Other advantages may be appreciated by one skilled in the art.

Provided herein are embodiments of a blade for unmanned aircraft vehicles, wherein the blade includes a base portion and an elongated portion extending longitudinally from the base portion to a tip portion, and wherein the elongated portion is adapted for extension and/or retraction in the longitudinal direction. In some embodiments, a lift area for each blade is at least about 1.1 times greater in an extended state as compared to a retracted state. In some embodiments, a fluid resistance of each blade is at least about 1.1 times greater in an extended state as compared to a retracted state. In some embodiments, a length of the blade extends at least about 5% in an extended as compared to a retracted state.

Provided herein are embodiments of a propeller for unmanned aircraft vehicles, wherein the propeller includes a hub portion adapted to fit on an unmanned aircraft system; and a plurality of blades extending longitudinally from a base portion to a tip portion, wherein the blades are adapted for extension and/or retraction in the longitudinal direction. In some embodiments, a lift area for each propeller is at least about 1.1 times greater in an extended state as compared to a retracted state. In some embodiments, a fluid resistance of each blade is at least about 1.1 times greater in an extended state as compared to a retracted state.

Provided herein are embodiments of an unmanned aircraft vehicle system, wherein the system includes a body and a control system within the body; and one or more propellers operably connected to the body, wherein the propeller includes a plurality of blades extending longitudinally from a base portion to a tip portion, wherein the blades are adapted for extension and/or retraction in the longitudinal direction. In some embodiments, a lift area of the one or more propellers is at least about 1.1 times greater in an extended state as compared to a retracted state. In some embodiments, a a wingspan of the one or more propellers is at least about 1.1 times greater in an extended state as compared to a retracted state. In some embodiments, the blades of the one or more propellers are adapted for extension and/or retraction in the longitudinal direction, thereby increasing and/or decreasing the propeller wingspan. In some embodiments, the system further includes a battery for powering the vehicle, wherein a life of the battery at least about 1.1 times greater when the blades are in an extended state compared to a retracted state. In some embodiments, a flight time, flight distance, and/or flight maximum height of the system with the battery is at least about 1.1 greater when the blades are in an extended state compared to a retracted state. In some embodiments, the control system causes extension and/or retraction between an extended state and a retracted state of the blades by an extension mechanism that utilizes centrifugal force, pressure, pneumatic force, electronic mechanism, and/or a mechanical mechanism. In some embodiments, the control system is programmed to automatically trigger an extension or retraction of the one or more blades based on an application or use of the unmanned aircraft vehicle system. In some embodiments, the control system is programmed to automatically trigger an extension or retraction of the one or more blades based on a size, weight, and/or volume of a package to be delivered. In some embodiments, the control system is programmed to automatically detect and/or trigger automatic retraction and/or extension of the blades based on an environmental condition. In some embodiments, the control system is programmed to automatically detect and/or trigger automatic retraction and/or extension of the blades based on an identified need for increased lift, decreased drag, and/or storage. In some embodiments, the system further includes a storage case with a cavity sized and arranged for receiving the unmanned aircraft system when the blades are in a longitudinally retracted state, but not when the blades are in a longitudinally extended state. In some embodiments, an overall volume space required to store the unmanned aircraft vehicle is at least about 1.1 times less in a retracted state as compared to an extended state. In some embodiments, the control system is programmed to automatically detect and/or trigger automatic retraction and/or extension of the blades based on: opening and/or closing of the case; placing and/or removing of the unmanned aerial vehicle in and/or from the case; and/or powering of the unmanned aerial vehicle on or off.

### BRIEF DESCRIPTION OF THE DRAWINGS

The novel and inventive features of the subject matter described herein are set forth with particularity in the appended claims. A better understanding of the feature and advantages of the present invention will be obtained by reference to the following detailed description that sets forth illustrative embodiments, in which the principles of the invention are utilized, and the accompanying drawings of which:

FIG. 1A is illustrative of a blade in a retracted state in one embodiment.

FIG. 1B is illustrative of the blade of FIG. 1A in an extended state.

FIGS. 2A and 2B illustrate a blade useful for unmanned aerial vehicles in another embodiment shown in a retracted state and extended state, respectively.

FIGS. 3A and 3B illustrate a propeller with two blades in retracted and extended states in one embodiment.

FIGS. 4A through 4C illustrate propellers in various embodiments.

FIGS. 5A and 5B illustrate an unmanned aircraft vehicle body in one embodiment.

FIGS. 6A and 6B illustrates an unmanned aircraft vehicle system in one embodiment.

FIG. 7 is an illustration of an unmanned aircraft vehicle system in one embodiment.

FIG. 8 illustrates an unmanned aircraft case in one embodiment.

### DETAILED DESCRIPTION OF THE INVENTION

### Blade

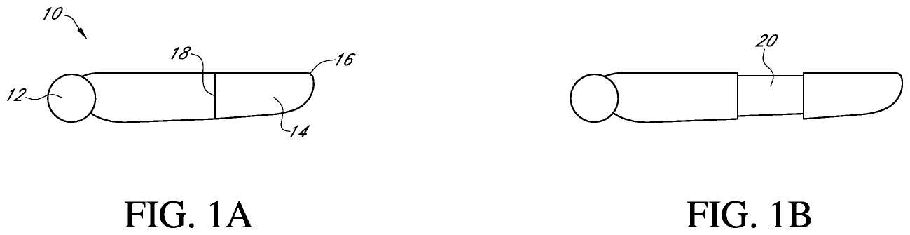

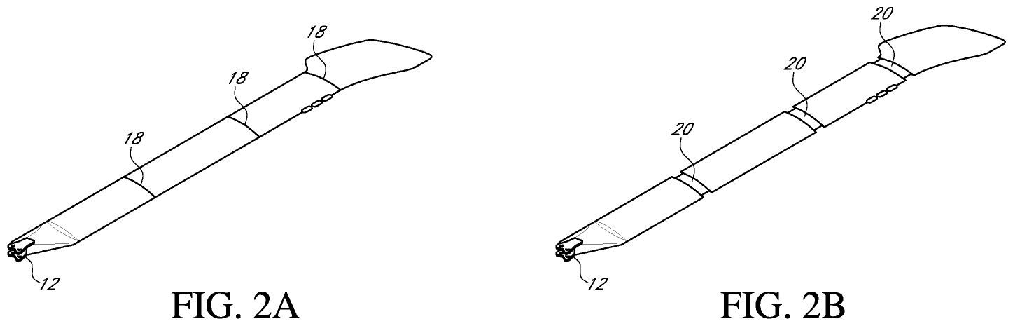

FIGS. 1A and 1B illustrate a blade 10 useful for unmanned aerial vehicles in one embodiment shown in a retracted state (FIG. 1A) and extended state (FIG. 1B), respectively. The blade 10 has a base portion 12 and a distal portion 14 extending longitudinally from the base portion, wherein the elongated portion is adapted for extension and/or retraction along the longitudinal axis of the blade that generally extends from the base portion 12 to the tip portion 16. FIG. 1A shows a seam 18 that may remain visible when the blade is its retracted state. FIG. 2A shows an extension portion 20 that allows for the distal portion 14 of the blade to slide or extend along its longitudinal axis and increase its overall length, and subsequently retract therefrom.

Although the blades of FIGS. 1A and 1B illustrate one embodiment with a sliding mechanism the achieve retractable/retractable states, other designs that may be used to achieve the extension/retraction include telescoping portions, bellows design, folding mechanism, and other expanding/collapsing mechanisms as may be appreciated by one skilled in the art. The configuration of blades may be made in any known airfoil shape and may have low, medium, or high pitch (e.g., 2, 3, 4, 5, 6 inch) as may be appreciated by one skilled in the art.

Once retracted, or extended, the blades may be locked into the selected state with a snap or twist lock, for example, however other locking mechanisms may be used as appreciated by one skilled in the art. The extension and/or retraction may be extended manually or automatically by a control system as described in more detail elsewhere herein.

In some embodiments, the lift area for each blade, propeller and/or drone is at least about 1.1, 1.2, 1.3, 1.4, 1.5, or 1.6 times greater in extended as compared to the retracted state. In some embodiments, the fluid resistance is at least about 1.1, 1.2, 1.3, 1.4, 1.5, or 1.6 times greater in the extended state as compared to the retracted state, thereby allowing for a reduction in drag by the same amount in the retracted state as compared to the extended state.

FIGS. 2A and 2B illustrate a blade useful for unmanned aerial vehicles in another embodiment shown in a retracted state and extended state, respectively. In this embodiment, the blade has a base portion 12 and is extendable/retractable along its longitudinal axis at a plurality of sections illustrated by seams 18 and extension portions 20. Alternate shaping and numbers of extension portions are also possible as may be appreciated by one skilled in the art.

### Propeller(s)

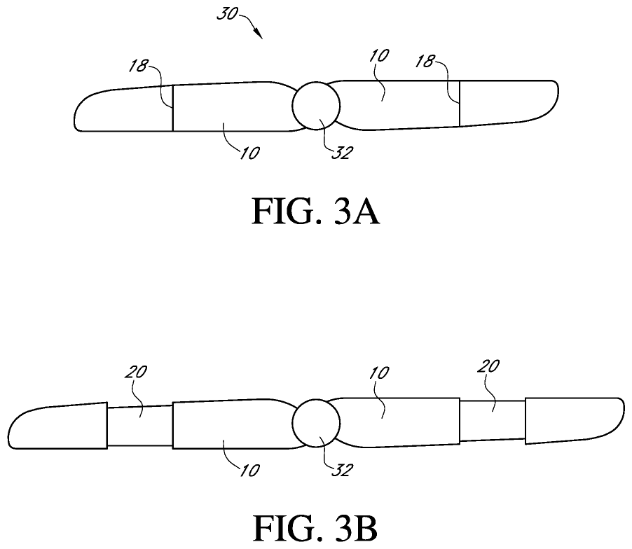

FIGS. 3A and 3B illustrate a propeller 30 with two blades 10 in retracted and extended states, respectively. In some embodiments, one or more propellers for an unmanned aircraft vehicle each include a hub portion 32 connected to the base portion 12 of each blade 10 and adapted to fit on the body of a drone. The hub has a plurality of blades extending therefrom, wherein the blades are adapted for extension and/or retraction in the longitudinal direction to thereby increase/decrease the propeller wingspan.

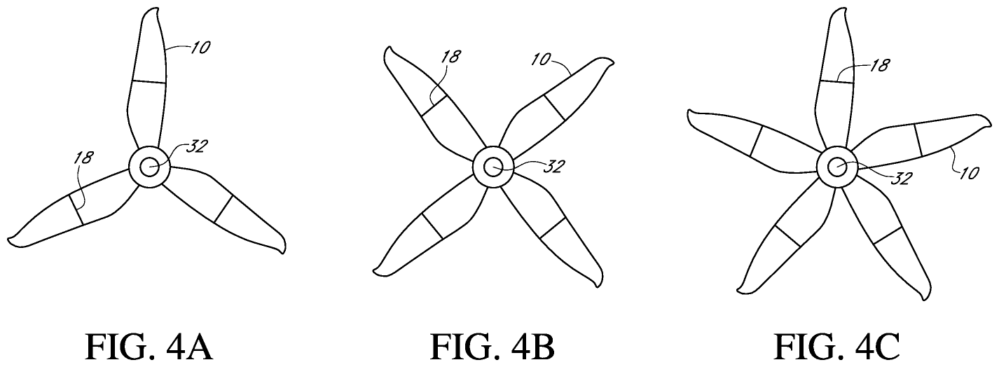

FIGS. 4A through 4C illustrate propellers in various embodiments showing that any reasonable number of extendable blades 10 may extend from the hub portion 32 is appreciated by one skilled in the art.

### Unmanned Aircraft Body

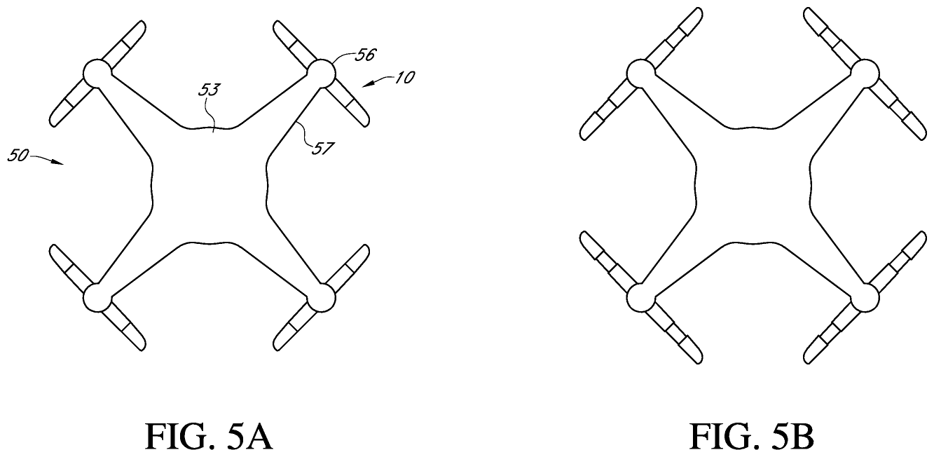

FIGS. 5A and 5B illustrate an unmanned aircraft vehicle body 50 shown with blades in the retracted state and extended state, respectively. In this embodiment, the body 50 has a central portion 53, four arms 57 and four propellers, each propeller having two extendable blades and being operably connected to the arms at the hub portion of the propeller at 56.

Although the illustrated embodiment shows four propellers connected to the body of the drone, other drone configurations may generally include anywhere from 3 to 8 arms (with connected propellers) or other configurations as appreciated by one skilled in the art.

The blades may lengthen or extend as far possible without creating interference with other blades, for example at least about 5, 10, 15, 20, 25, 30, 35, 40, 45, or 50% more along the longitudinal axis of the blade.

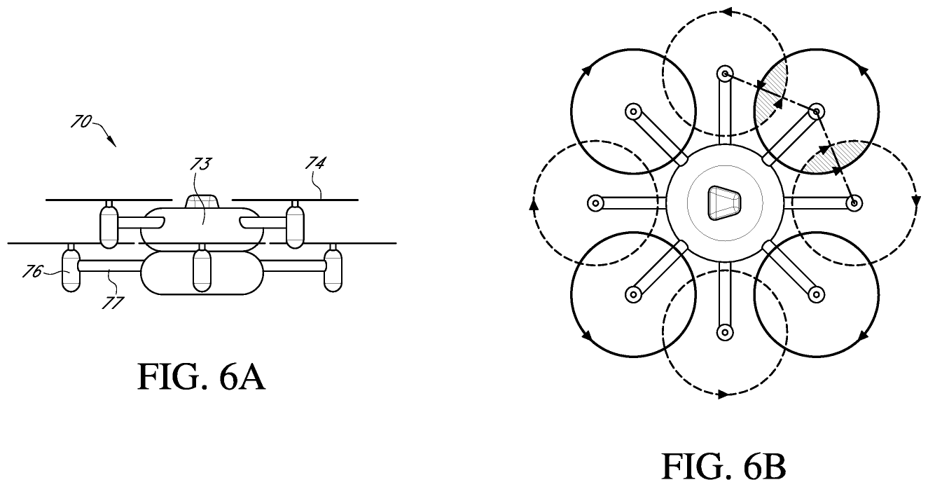

FIGS. 6A and 6B illustrate side and top views of an unmanned aircraft vehicle system 70 having stackable bodies, some or all of which propellers have extendable blades in various embodiments.

FIG. 6A illustrates a first (upper) drone body 73 coupled to a second (lower) drone body forming a combined unmanned aerial vehicle with as much as twice the lift of a single drone. Each of the upper and lower drone bodies have arms 77 with rotors 76 that drive the propellers 74 in clockwise or counterclockwise rotation to neutralize net torque as is appreciated by one skilled in the art. In this embodiment, the drone bodies are connected such that the propellers are rotationally offset from each other by 45 degrees about a central vertical axis so the propellers are staggered. However, offsets are possible such as a 90-degree offset that provides coaxial counter-rotating propellers in the stack of drones. Together, the extendable blades with the stacked design allow for increased lift without the interference of the blades.

FIG. 6B is a top view of the stacked drones of FIG. 6B. The lower drone may be positioned such that the lower propeller disks maximally overlap in beneficial areas (hatched) while not overlapping the motors or motor arms in the top view. Legs may optionally extend downward and outward from the motors or motor arms. In some embodiments, any even number of propellers may utilize the extendable blades described herein to achieve even more lift, clearance, and/or sizing configurations, wherein an even number of clockwise and counterclockwise rotating propellers with extendable blades are designed to neutralize net torque.

Other UAV configurations are also possible, such as helicopter style drone with a propeller having extendable blades.

### Unmanned Aircraft Vehicle System

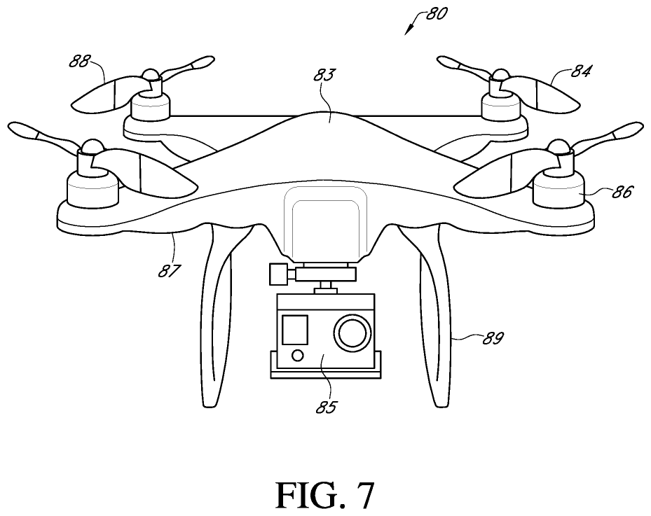

FIG. 7 is an illustration of an unmanned aircraft vehicle system 80 having a body 83 with landing gear 89, arms 87, and propellers 84 connected to the arms 87 at the rotor 86. The system, in addition to a control system (hidden within body) having standard electronics such as controller(s), power source(s) and a power board, also includes a camera 85 operably connected to the body for environmental activities such as photography or search and rescue. In the illustrated embodiment, the four propellers 84 each have two blades 88 adapted for extension and/or retraction in the longitudinal direction.

Unmanned aircraft vehicles including the extendable blades described herein have a battery life at least about 1.1, 1.2, 1.3, 1.4, 1.5, or 1.6 times greater when the blades are in an extended state compared to a retracted state. Unmanned aircraft vehicles including the extendable blades described herein have a flight time, distance, and/or height (on a single battery) of at least about 1.1, 1.2, 1.3, 1.4, 1.5, or 1.6 times greater when the blades are in an extended state compared to a retracted state.

In some embodiments, the control system causes the extension (and retraction) between the extended and retracted states of an extension mechanism of the drone utilizing centrifugal force, pressure, pneumatic force, electronic mechanism, and/or a mechanical mechanism. The extension/retraction of the blades may be triggered based on a need for increased lift, decreased drag, and/or simply for storage needs. The trigger for extension and/or retraction may be programmable and/or user-selected based on the current drone application or use. For example, the size of a package could automatically trigger an extension or retraction of the one or more blades. Environmental conditions could be detected and trigger automatic retraction and/or extension based on the programming, for example, population density, weather conditions, etc. The extension and/or retraction may be triggered upon opening a case or removing the drone from a case and/or powering the drone on or off.

### Case

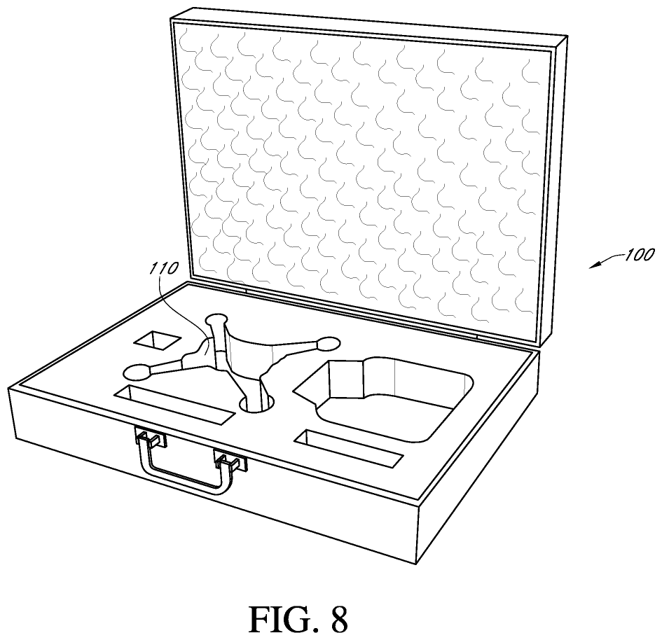

FIG. 8 illustrates an unmanned aircraft a case 100 sized and arranged for receiving the unmanned aircraft vehicle within a fitted cavity 110 when the blades are in a retracted state, but not when the blades are in an extended state. This allows for compact storage and easy travel for a drone with high utility. In some embodiments, the overall volume space required to store a drone (with a propeller/blades) is at least about 1.1, 1.2, 1.3, 1.4, 1.5, or 1.6 times less in the retracted state as compared to the extended state.

### Control System

The methods, software, media, and systems disclosed herein comprise at least one computer processor, or use of the same. The computer processor may comprise a computer program. A computer program may include a sequence of instructions, executable in the digital processing device's CPU, written to perform a specified task. Computer readable instructions may be implemented as program modules, such as functions, features, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. A computer program may comprise one sequence of instructions. A computer program may comprise a plurality of sequences of instructions. A computer program may be provided from one location. A computer program may be provided from a plurality of locations. A computer program may include one or more software modules. A computer program may include, in part or in whole, one or more web applications, one or more mobile applications, one or more standalone applications, one or more web browser plug-ins, extensions, add-ins, or add-ons, or combinations thereof.

The examples and embodiments described herein are for illustrative purposes only and various modifications or changes suggested to persons skilled in the art are to be included within the spirit and purview of this application and scope of the appended claims.

What is claimed is:

1. A blade for unmanned aircraft vehicles, the blade comprising:
a base portion; and
an elongated portion extending longitudinally from the base portion to a tip portion, wherein the elongated portion is adapted for extension and/or retraction in the longitudinal direction.

2. The blade of claim 1, wherein a lift area for each blade is at least about 1.1 times greater in an extended state as compared to a retracted state.

3. The blade of claim 1, wherein a fluid resistance of each blade is at least about 1.1 times greater in an extended state as compared to a retracted state.

4. The blade of claim 1, wherein a length of the blade extends at least about 5% in an extended as compared to a retracted state.

5. A propeller for unmanned aircraft vehicles, the propeller comprising:
a hub portion adapted to fit on an unmanned aircraft system; and
a plurality of blades extending longitudinally from a base portion to a tip portion, wherein the blades are adapted for extension and/or retraction in the longitudinal direction.

6. The propeller of claim 5, wherein a lift area for each propeller is at least about 1.1 times greater in an extended state as compared to a retracted state.

7. The propeller of claim 5, wherein a fluid resistance of each blade is at least about 1.1 times greater in an extended state as compared to a retracted state.

8. An unmanned aircraft vehicle system, the system comprising:
a body and a control system within the body; and
one or more propellers operably connected to the body, wherein the propeller comprises a plurality of blades extending longitudinally from a base portion to a tip portion, wherein the blades are adapted for extension and/or retraction in the longitudinal direction.

9. The unmanned aircraft vehicle system of claim 8, wherein a lift area of the one or more propellers is at least about 1.1 times greater in an extended state as compared to a retracted state.

10. The unmanned aircraft vehicle system of claim 8, wherein a wingspan of the one or more propellers is at least about 1.1 times greater in an extended state as compared to a retracted state.

11. The unmanned aircraft vehicle system of claim 8, wherein the blades of the one or more propellers are adapted for extension and/or retraction in the longitudinal direction, thereby increasing and/or decreasing the propeller wingspan.

12. The unmanned aircraft vehicle system of claim 8, further comprising a battery for powering the vehicle, wherein a life of the battery at least about 1.1 times greater when the blades are in an extended state compared to a retracted state.

13. The unmanned aircraft vehicle system of claim 12, wherein a flight time, flight distance, and/or flight maximum height of the system with the battery is at least about 1.1 greater when the blades are in an extended state compared to a retracted state.

14. The unmanned aircraft vehicle system of claim 8, wherein the control system causes extension and/or retraction between an extended state and a retracted state of the blades by an extension mechanism that utilizes centrifugal force, pressure, pneumatic force, electronic mechanism, and/or a mechanical mechanism.

15. The unmanned aircraft vehicle system of claim 8, wherein the control system is programmed to automatically trigger an extension or retraction of the one or more blades based on an application or use of the unmanned aircraft vehicle system.

16. The unmanned aircraft vehicle system of claim 8, wherein the control system is programmed to automatically trigger an extension or retraction of the one or more blades based on a size, weight, and/or volume of a package to be delivered.

17. The unmanned aircraft vehicle system of claim 8, wherein the control system is programmed to automatically detect and/or trigger automatic retraction and/or extension of the blades based on an environmental condition.

18. The unmanned aircraft vehicle system of claim 8, wherein the control system is programmed to automatically detect and/or trigger automatic retraction and/or extension of the blades based on an identified need for increased lift, decreased drag, and/or storage.

19. The unmanned aircraft vehicle system of claim 8, further comprising a storage case comprising a cavity sized and arranged for receiving the unmanned aircraft system when the blades are in a longitudinally retracted state, but not when the blades are in a longitudinally extended state.

20. The unmanned aircraft vehicle system of claim 19, wherein overall volume space required to store the unmanned aircraft vehicle is at least about 1.1 times less in a retracted state as compared to an extended state.

21. The unmanned aircraft vehicle system of claim 19, wherein the control system is programmed to automatically detect and/or trigger automatic retraction and/or extension of the blades based on: opening and/or closing of the case; placing and/or removing of the unmanned aerial vehicle in and/or from the case; and/or powering of the unmanned aerial vehicle on or off.
